(19) United States
(12) Patent Application Publication
(10) Pub. No.: US 2017/0351113 A1
(43) Pub. Date: Dec. 7, 2017

(54) OPTICAL SYSTEM AND IMAGE PICKUP APPARATUS INCLUDING THE SAME

(71) Applicant: CANON KABUSHIKI KAISHA, Tokyo (JP)

(72) Inventors: Suguru Inoue, Utsunomiya-shi (JP); Shigenobu Sugita, Shimotsuke-shi (JP)

(21) Appl. No.: 15/609,786

(22) Filed: May 31, 2017

(30) Foreign Application Priority Data
Jun. 1, 2016 (JP) 2016-109877

(51) Int. Cl. G02B 27/64; G02B 13/02; G02B 7/04

(52) U.S. Cl. CPC G02B 27/646; G02B 7/04; G02B 13/02

(57) ABSTRACT

Provided is an optical system including, in order from an object side to an image side: a first lens unit having a positive refractive power; an aperture stop; and a second lens unit having a negative refractive power, the second lens unit including: a focusing lens sub-unit which is moved on an optical axis during focusing; and an image stabilizing lens sub-unit, which is arranged between the focusing lens sub-unit and an image plane, and is moved in a direction having a component orthogonal to the optical axis during image stabilization, in which the configuration of the first lens unit, a focal length of the entire system, and a distance between the first lens unit and the second lens unit on the optical axis when focused at infinity are each appropriately set.

### BACKGROUND OF THE INVENTION

### Field of the Invention

The present invention relates to an optical system and an image pickup apparatus including the same, which are suitable for, for example, an image pickup optical system to be used for image pickup apparatus such as a digital still camera, a digital video camera, a television (TV) camera, and a monitoring camera.

### Description of the Related Art

Optical systems that are used in image pickup apparatus are demanded, for example, to have a short lens total length and high optical performance, and be light as a whole. In addition, the optical systems are demanded to enable easy quick focusing, and have an image stabilization function for correcting an image blur by shaking, thereby preventing reduction in optical performance, for example.

Telephoto image pickup optical systems have hitherto been known as optical systems satisfying those demands. In each of Japanese Patent Application Laid-Open No. 2015-108811 and Japanese Patent Application Laid-Open No. 2015-108814, there is disclosed an image pickup optical system, including, in order from an object side to an image side, a first lens unit having a positive refractive power, an aperture stop, and a second lens unit having a negative refractive power. In the image pickup optical system, focusing is performed by a focusing unit that is a part of the second lens unit, and an image blur is corrected by an image stabilizing unit that is a part of the second lens unit, and is different from the focusing unit.

In general, as the focal length of a telephoto optical system is increased, the entire lens system is increased in size and weight. Thus, it is important to reduce the telephoto optical system in size and weight as the entire lens system. Further, it is important to quickly perform focusing and image stabilization by a compact and lightweight lens unit while reducing a load on a driving device, for example. In the telephoto optical system, it is important to appropriately set the lens configuration of each lens unit in order to achieve easy focusing with a small amount of aberration variations during focusing, and easy image stabilization while maintaining satisfactory optical performance during image stabilization.

### SUMMARY OF THE INVENTION

The present invention has an object to provide an optical system enabling quick focusing, in which satisfactory optical performance is easily maintained even during image stabilization, the entire system is easily reduced in size, and the lens weight is easily reduced, and an image pickup apparatus including the optical system.

According to one embodiment of the present invention, there is provided an optical system, comprising, in order from an object side to an image side: a first lens unit having a positive refractive power; an aperture stop; and a second lens unit having a negative refractive power, the second lens unit comprising: a focusing lens sub-unit which is moved during focusing; and an image stabilizing lens sub-unit which is arranged on the image side of the focusing lens sub-unit and is moved in a direction having a component orthogonal to an optical axis during image stabilization, the first lens unit consisting of, in order from the object side to the image side, a first lens sub-unit having a positive refractive power and a second lens sub-unit having a positive refractive power that are separated from each other by a widest air interval in the first lens unit on the optical axis, in which the following conditional expressions are satisfied:

0.005<d12/f<0.045; and

0.4<d1/f1<1.2,

where f represents a focal length of the optical system, d12 represents a distance between the first lens unit and the second lens unit on the optical axis when focused at infinity, d1 represents a distance between the first lens sub-unit and the second lens sub-unit on the optical axis, and f1 represents a focal length of the first lens unit.

Further features of the present invention will become apparent from the following description of exemplary embodiments with reference to the attached drawings.

### BRIEF DESCRIPTION OF THE DRAWINGS

FIG. 1 is a lens cross-sectional view of an optical system according to Embodiment 1 of the present invention when an object distance is infinity.

FIG. 2 is aberration diagrams of the optical system according to Embodiment 1 of the present invention when the object distance is infinity.

FIG. 3 is a lens cross-sectional view of an optical system according to Embodiment 2 of the present invention when the object distance is infinity.

FIG. 4 is aberration diagrams of the optical system according to Embodiment 2 of the present invention when the object distance is infinity.

FIG. 5 is a lens cross-sectional view of an optical system according to Embodiment 3 of the present invention when the object distance is infinity.

FIG. 6 is aberration diagrams of the optical system according to Embodiment 3 of the present invention when the object distance is infinity.

FIG. 7 is a lens cross-sectional view of an optical system according to Embodiment 4 of the present invention when the object distance is infinity.

FIG. 8 is aberration diagrams of the optical system according to Embodiment 4 of the present invention when the object distance is infinity.

FIG. 9 is a lens cross-sectional view of an optical system according to Embodiment 5 of the present invention when the object distance is infinity.

FIG. 10 is aberration diagrams of the optical system according to Embodiment 5 of the present invention when the object distance is infinity.

FIG. 11 is an explanatory diagram of an image pickup apparatus of the present invention.

### DESCRIPTION OF THE EMBODIMENTS

In the following, exemplary embodiments of the present invention are described with reference to the attached drawings. An optical system of the present invention includes, in order from an object side to an image side, a first lens unit having a positive refractive power, an aperture stop, and a second lens unit having a negative refractive power. The second lens unit includes a focusing lens sub-unit configured to move during focusing, and an image stabilizing lens sub-unit that is arranged on the image side of the focusing lens sub-unit, and is configured to move in a direction having a component orthogonal to an optical axis during image stabilization.

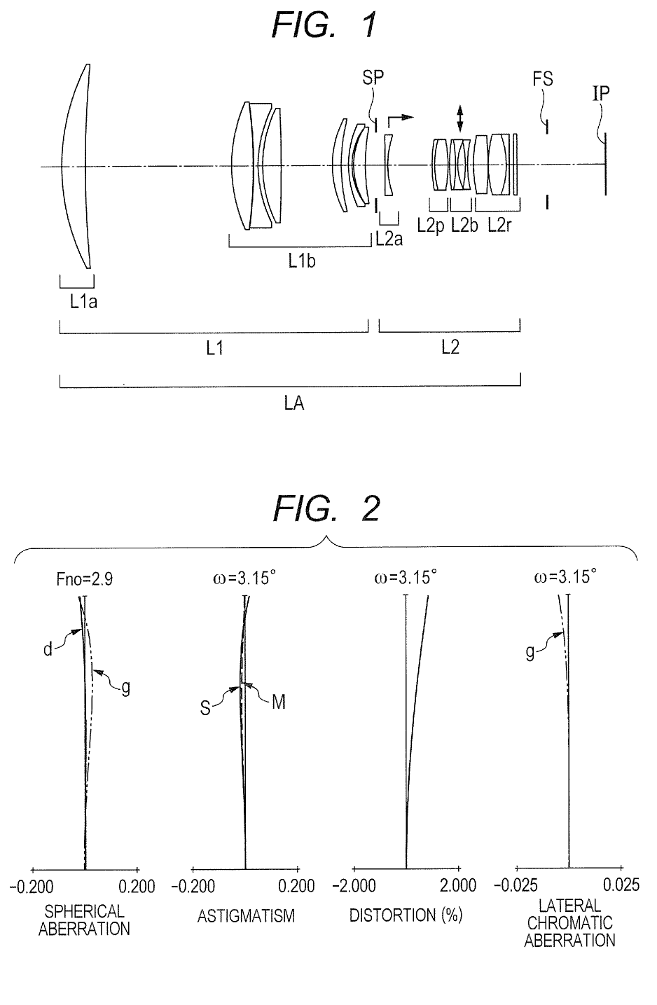

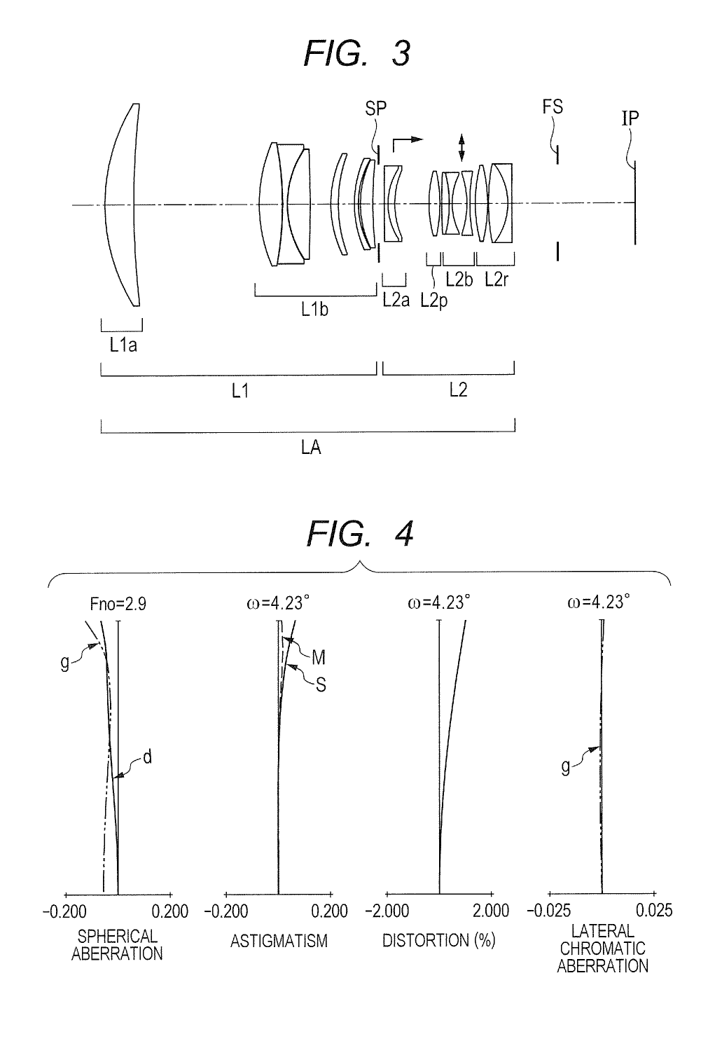

FIG. 1 is a lens cross-sectional view of an optical system according to Embodiment 1 of the present invention when focused at infinity. FIG. 2 is aberration diagrams of the optical system according to Embodiment 1 of the present invention when focused at infinity. The optical system of Embodiment 1 is a telephoto optical system having an F-number of 2.90 and an image pickup angle of view of 6.3°. FIG. 3 is a lens cross-sectional view of an optical system according to Embodiment 2 of the present invention when focused at infinity. FIG. 4 is aberration diagrams of the optical system according to Embodiment 2 of the present invention when focused at infinity. The optical system of Embodiment 2 is a telephoto optical system having an F-number of 2.90 and an image pickup angle of view of 8.46°.

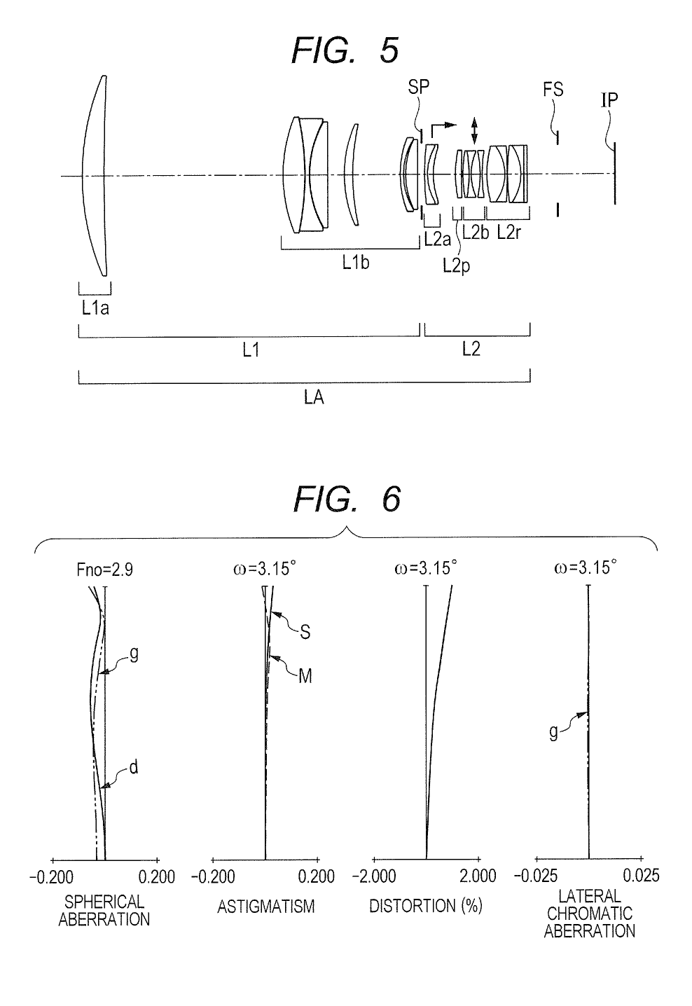

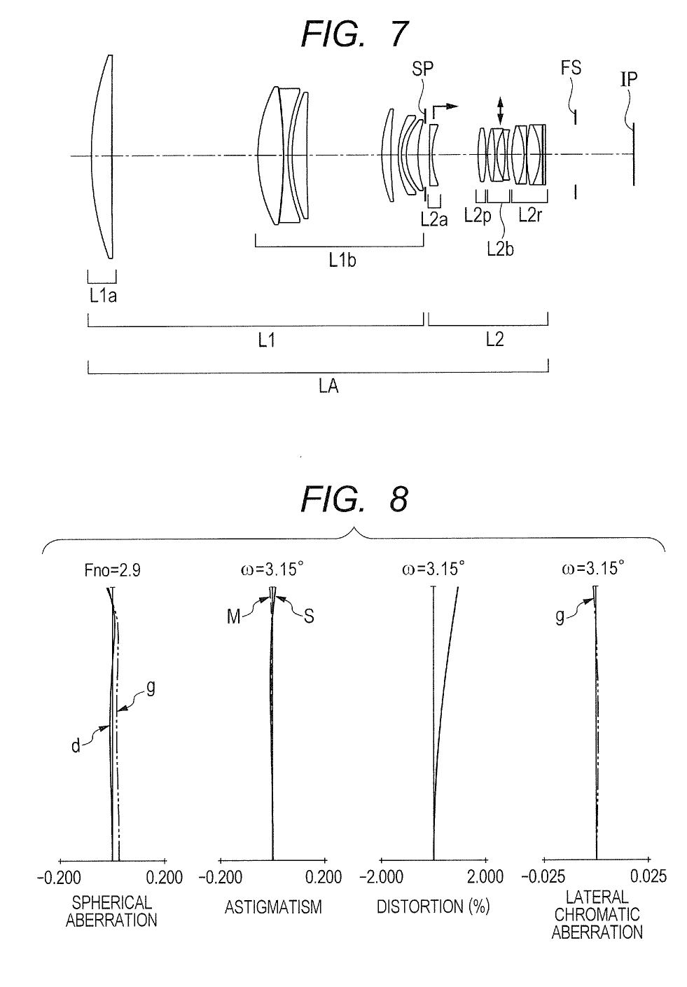

FIG. 5 is a lens cross-sectional view of an optical system according to Embodiment 3 of the present invention when focused at infinity. FIG. 6 is aberration diagrams of the optical system according to Embodiment 3 of the present invention when focused at infinity. The optical system of Embodiment 3 is a telephoto optical system having an F-number of 2.90 and an image pickup angle of view of 6.3°. FIG. 7 is a lens cross-sectional view of an optical system according to Embodiment 4 of the present invention when focused at infinity. FIG. 8 is aberration diagrams of the optical system according to Embodiment 4 of the present invention when focused at infinity. The optical system of Embodiment 4 is a telephoto optical system having an F-number of 2.90 and an image pickup angle of view of 6.3°.

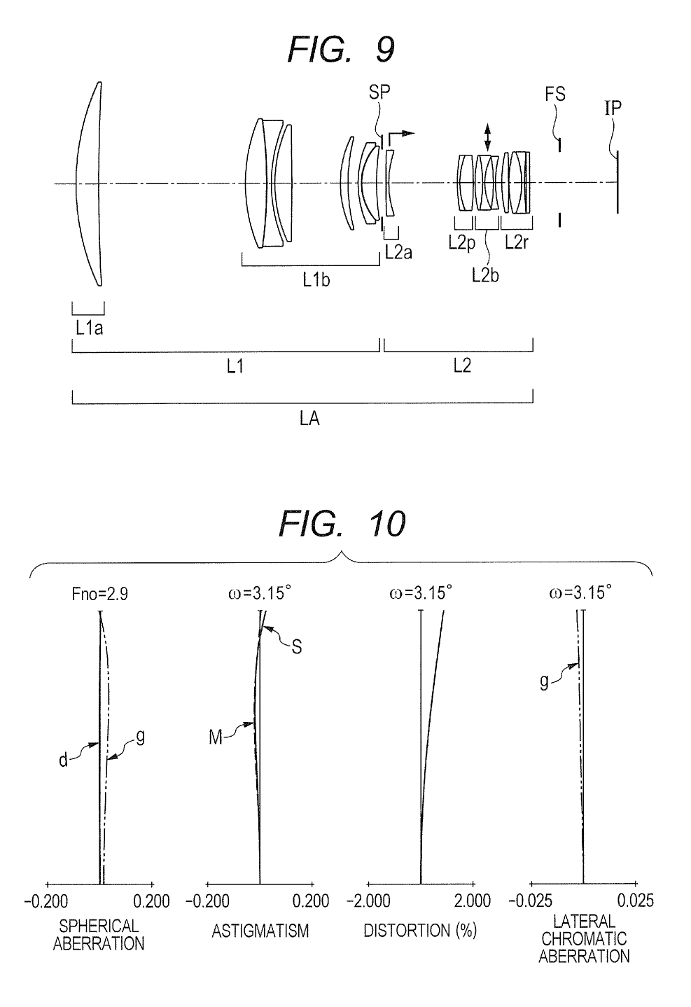

FIG. 9 is a lens cross-sectional view of an optical system according to Embodiment 5 of the present invention when focused at infinity. FIG. 10 is aberration diagrams of the optical system according to Embodiment 5 of the present invention when focused at infinity. The optical system of Embodiment 5 is a telephoto optical system having an F-number of 2.90 and an image pickup angle of view of 6.3°.

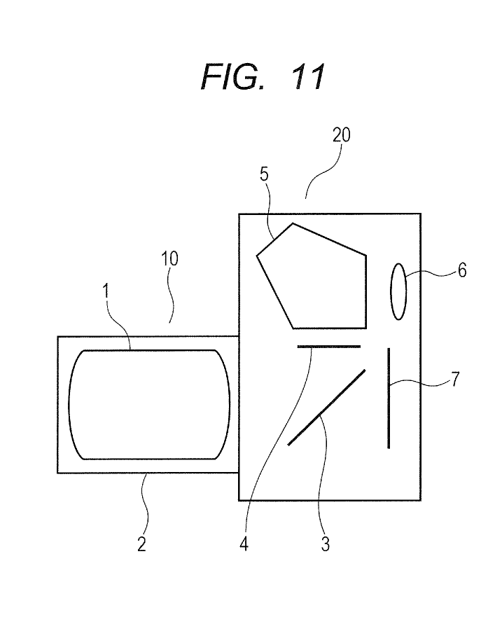

FIG. 11 is a schematic diagram of a main part of a single-lens reflex camera system (image pickup apparatus) having the optical system of the present invention mounted on a body of the camera. In each lens cross-sectional view, there is illustrated an optical system LA. A first lens unit L1 has a positive refractive power, an aperture stop SP determines the maximum diameter of an axial ray, and a second lens unit L2 has a negative refractive power. The first lens unit L1 consists of, in order from the object side to the image side, a first lens sub-unit L1a having a positive refractive power and a second lens sub-unit L1b having a positive refractive power that are separated from each other by the widest air interval.

Further, the second lens unit L2 includes a focusing lens sub-unit L2a configured to move on the optical axis during focusing. Still further, the second lens unit L2 includes an image stabilizing lens sub-unit L2b that is arranged on the image side of the focusing lens sub-unit L2a, and is configured to move in the direction having the component orthogonal to the optical axis during image stabilization. Yet further, the second lens unit L2 includes a lens sub-unit L2p having a positive refractive power between the focusing lens sub-unit L2a and the image stabilizing lens sub-unit L2b. A flare cut stop FS has a fixed aperture diameter, and is arranged on the image side of the lens closest to the image side. However, the arrangement of the flare cut stop FS is not limited to the above-mentioned arrangement.

An image plane IP corresponds to an image pickup surface of an image pickup element (photoelectric conversion element) such as a CCD sensor or a CMOS sensor configured to receive light of images when the optical system is used as a photographing optical system for use in a video camera or a digital camera, and corresponds to a film surface when the optical system is used as an image pickup optical system of a silver-halide film camera. In each spherical aberration diagram and each lateral chromatic aberration diagram of the aberration diagrams, d represents a d-line (wavelength of 587.6 nm), and g represents a g-line (wavelength of 435.8 nm). In each astigmatism diagram, a dotted line M represents a meridional image plane of the d-line, and a solid line S represents a sagittal image plane of the d-line.

Fno represents an F-number and ω represents a half angle of view (degree). When each Numerical Embodiment, which is described later, is expressed in units of mm, the spherical aberration, the astigmatism, the distortion, and the lateral chromatic aberration are respectively drawn on scales of 0.2 mm, 0.2 mm, 2%, and 0.025 mm throughout all the aberration diagrams. The optical system LA of each Embodiment is a telephoto optical system and has the following structural features.

The optical system of each Embodiment employs, in order to reduce the lens total length, a telephoto type including, in order from the object side to the image side, the first lens unit L1 having a positive refractive power, and the second lens unit L2 having a negative refractive power. Here, the lens total length refers to a value obtained by adding an equivalent back focus in air to a distance from a first lens surface on the object side to a last lens surface. The back focus refers to an equivalent air length from the last lens surface to the image plane. Further, the aperture stop, the focusing unit, and an image blur correcting unit, which require drive mechanisms, are arranged in the stated order from the object side to the image side.

In the optical system LA of each Embodiment, a ray is converged by the lens closest to the object side, and a second lens and subsequent lenses are arranged as close to the image side as possible in order to reduce the lens in size and weight. Thus, in determining the order of each mechanism, it is important to consider the degree of freedom thereof in the optical axis direction so that each mechanism can be easily arranged.

The degree of freedom of the arrangement of the mechanisms for driving the focusing unit and the image blur correcting unit in the optical axis direction is high because the mechanisms and the optical system can be moved in the optical axis direction to a certain degree through extension of a lens barrel holding the optical system, for example. Further, the focusing unit and the image blur correcting unit may not necessarily be rotationally symmetric about the optical axis depending on a selected actuator or the like. For example, a space in the optical axis direction can be effectively utilized with a nested structure.

On the other hand, the mechanism for the aperture stop SP is achieved by a stop diaphragm expanding on the radially inner side, which is housed in the radially outer direction. Hence, it is optically difficult to move the arrangement of the drive mechanism in the optical axis direction relative to a position at which the aperture stop SP is supposed to be arranged. In addition, the aperture stop SP is a member configured to at least determine an axial ray, and to determine an effective ray of an off-axial ray with a small aperture. Thus, in order to obtain images with good bokeh and light amount distribution, the aperture stop SP is required to be rotationally symmetric about the optical axis. It is therefore difficult to employ a nested structure, and the degree of freedom of the arrangement of the mechanism in the optical axis direction is low.

Due to the forgoing, the mechanisms are arranged in the following order: the focusing mechanism and the image blur correcting (image stabilizing) mechanism, which are high in degree of freedom, are adjacent to each other, and the aperture stop SP is arranged on the object side of the focusing mechanism and the image stabilization mechanism from the consistency with the pupil position of the telephoto optical system.

In the optical system of each Embodiment, the second lens unit L2 includes the focusing lens sub-unit L2a that has a negative refractive power, and is configured to move on the optical axis for focusing. In addition, the second lens unit L2 includes the image stabilizing lens sub-unit L2b that has a negative refractive power, and is configured to move in the direction having the component orthogonal to the optical axis for image stabilization.

The first lens unit L1 consists of, in order from the object side to the image side, the first lens sub-unit L1a having a positive refractive power and the second lens sub-unit L1b having a positive refractive power that are separated from each other by the widest air interval in the first lens unit on the optical axis. A distance between the first lens sub-unit L1a and the second lens sub-unit L1b on the optical axis is represented by d1.

Here, the focal length of the entire system is represented by f, a distance between the first lens unit L1 and the second lens unit L2 on the optical axis when focused at infinity is represented by d12, and the focal length of the first lens unit L1 is represented by f1. In this case, the optical system of each Embodiment satisfies the following conditional expressions.

0.005<d12/f<0.045 (1)

0.4<d1/f1<1.2 (2)

Next, the technical meanings of the above-mentioned conditional expressions are described. Conditional Expression (1) is intended to appropriately set the distance between the first lens unit L1 and the second lens unit L2 on the optical axis, thereby reducing the entire system in size and weight while maintaining high optical performance. When the value falls below the lower limit value of Conditional Expression (1), it is difficult to arrange the aperture stop SP between the first lens unit L1 and the second lens unit L2. When the value exceeds the upper limit value of Conditional Expression (1), the lens total length is increased, and the lenses included in the first lens unit L1 are greatly biased toward the object side, with the result that it is difficult to reduce the entire system in weight.

Conditional Expression (2) relates to the distance between the first lens sub-unit L1a and the second lens sub-unit L1b on the optical axis. When the second lens sub-unit L1b is greatly biased toward the object side and the value falls below the lower limit value of Conditional Expression (2), the second lens sub-unit L1b is increased in size, and it is difficult to reduce the entire system in size and weight. Alternatively, the positive refractive power of the first lens unit L1 is increased too much, with the result that various aberrations such as spherical aberration and axial chromatic aberration are increased, and it is difficult to reduce those various aberrations, which is not preferred.

When the second lens sub-unit L1b is greatly biased toward the image side and the value exceeds the upper limit value of Conditional Expression (2), it is difficult to arrange the focusing mechanism and the image stabilization mechanism in the second lens unit L2 while reducing the entire system in size. Alternatively, the positive refractive power of the first lens unit L1 is reduced too much, and the entire lens system is increased in size, which is not preferred.

The numerical ranges of Conditional Expressions (1) and (2) are more preferably set as follows.

0.010<d12/f<0.040 (1a)

0.5<d1/f1<1.0 (2a)

The optical system that is the object of the present invention is achieved by the above-mentioned configuration. However, in order to obtain high optical performance while further reducing the entire system in weight, at least one of the following conditional expressions is desirably satisfied. The focal length of the second lens unit L2 is represented by f2. The focal length of the focusing lens sub-unit L2a is represented by f2a.

The focal length of the first lens sub-unit L1a is represented by fla, and the focal length of the second lens sub-unit L1b is represented by flb. A distance from the lens surface closest to the object side to the image plane on the optical axis (lens total length) is represented by Lo. A distance from the lens surface closest to the image side to the image plane on the optical axis (back focus) is represented by Sk. The focal length of the image stabilizing lens sub-unit L2b is represented by f2b. In this case, at least one of the following conditional expressions is preferably satisfied.

−0.53<f2/f<−0.19 (3)

−1.90<f1/f2<−0.80 (4)

0.30<f2a/f2<0.80 (5)

1.4<f1a/f1b<7.0 (6)

0.8<Lo/f<1.1 (7)

0.09<Sk/f<0.25 (8)

0.15<f2b/f2<0.50 (9)

Next, the technical meanings of the respective conditional expressions described above are described. Conditional Expression (3) relates to the negative refractive power of the second lens unit L2. When the negative refractive power of the second lens unit L2 is reduced too much (the absolute value of the negative refractive power is reduced too much) and the value falls below the lower limit value of Conditional Expression (3), the power arrangement of the telephoto type is weakened, and the entire lens system is increased in size. When the negative refractive power of the second lens unit L2 is increased too much (the absolute value of the negative refractive power is increased too much) and the value exceeds the upper limit value of Conditional Expression (3), various aberrations such as curvature of field and coma are increased, and it is difficult to correct those various aberrations.

Conditional Expression (4) relates to the ratio of the positive refractive power of the first lens unit L1 to the negative refractive power of the second lens unit L2. When the value falls below the lower limit value or exceeds the upper limit value of Conditional Expression (4), it is difficult to obtain a telephoto optical system, and the lens total length is increased, which is not preferred.

Conditional Expression (5) relates to the ratio of the negative refractive power of the focusing lens sub-unit L2a to the negative refractive power of the second lens unit L2. When the negative refractive power of the focusing lens sub-unit L2a is increased too much and the value falls below the lower limit value of Conditional Expression (5), aberration variations during focusing are increased, which is not preferred. When the negative refractive power of the focusing lens sub-unit L2a is reduced too much and the value exceeds the upper limit value of Conditional Expression (5), the movement amount during focusing is increased. As a result, the focusing lens sub-unit L2a and the subsequent lenses are required to be arranged on the image side, and it is difficult to reduce the entire system in size and weight.

Conditional Expression (6) relates to the ratio of the focal length of the first lens sub-unit L1a to the focal length of the second lens sub-unit L1b. When the positive refractive power of the first lens sub-unit L1a is increased too much and the value falls below the lower limit value of Conditional Expression (6), spherical aberration and axial chromatic aberration are increased, and it is difficult to correct those various aberrations. When the positive refractive power of the first lens sub-unit L1a is reduced too much and the value exceeds the upper limit value of Conditional Expression (6), the effect of converging an incident ray is weakened, and the effect of reducing the second lens unit L2 in size and weight is weakened, which is not preferred.

Conditional Expression (7) relates to the ratio of the lens total length to the focal length of the entire system. When the lens total length is reduced and the value falls below the lower limit value of Conditional Expression (7), the refractive power of each lens unit is required to be increased, with the result that various aberrations are increased, and it is difficult to correct the various aberrations, which is not preferred. When the value exceeds the upper limit value of Conditional Expression (7), the lens total length is increased, and the entire system is increased in size, which is not preferred.

Conditional Expression (8) relates to the ratio of the back focus to the focal length of the entire system. When the back focus is reduced too much and the value falls below the lower limit value of Conditional Expression (8), it is difficult to arrange elements necessary for the image pickup apparatus, for example, a quick return mirror, a low-pass filter, and a prism, which is not preferred. When the back focus is increased too much and the value exceeds the upper limit value of Conditional Expression (8), the lenses included in the second lens unit L2 are greatly biased toward the object side, and it is difficult to reduce the entire system in size and weight, which is not preferred.

Conditional Expression (9) relates to the ratio of the focal length of the image stabilizing lens sub-unit L2b to the focal length of the second lens unit L2. When the negative refractive power of the image stabilizing lens sub-unit L2b is increased too much and the value falls below the lower limit value of Conditional Expression (9), it is difficult to reduce aberration variations during image stabilization, which is not preferred. When the negative refractive power of the image stabilizing lens sub-unit L2b is reduced too much and the value exceeds the upper limit value of Conditional Expression (9), the sensitivity during image stabilization is reduced, and the movement amount to the image stabilizing lens sub-unit L2b during image stabilization is increased, which is not preferred. The numerical ranges of Conditional Expressions (3) to (9) are more preferably set as follows.

−0.51<f2/f<−0.21 (3a)

−1.85<f1/f2<−0.90 (4a)

0.32<f2a/f2<0.77 (5a)

1.5<f1a/f1b<5.5 (6a)

0.85<Lo/f<1.00 (7a)

0.13<Sk/f<0.23 (8a)

0.19<f2b/f2<0.45 (9a)

In order to obtain excellent optical performance while reducing the entire system in size and weight in each Embodiment, the following configuration is preferably employed. The first lens sub-unit L1a preferably consists of one lens element. Here, the lens element refers to a single lens or a cemented lens obtained by cementing a plurality of lenses.

In the optical system LA of each Embodiment of the present invention, the focusing lens sub-unit L2a is preferably arranged on the image side of the aperture stop SP to be adjacent to the aperture stop SP. No lens is provided between the aperture stop SP and the focusing lens sub-unit L2a. With this, the aperture stop SP is arranged relatively on the image side so that high-speed drive is facilitated while the mechanism for the aperture stop SP is reduced in size and weight.

The lens surface of the first lens unit L1 that is closest to the image side is preferably concave on the image side. The focusing lens sub-unit L2a preferably consists of one lens element. The focusing lens sub-unit L2a is preferably configured to move toward the image side during focusing from infinity to close distance. Further, at this time, only the focusing lens sub-unit L2a is preferably a lens unit configured to move in the optical axis direction during focusing. The image stabilizing lens sub-unit L2b preferably has a negative refractive power.

In each Embodiment, the lens sub-unit L2p having a positive refractive power is preferably provided between the focusing lens sub-unit L2a and the image stabilizing lens sub-unit L2b. The lens sub-unit L2p converges a ray entering the image stabilizing lens sub-unit L2b having the image stabilization function, and further, enhances the refractive power by being paired with the image stabilizing lens sub-unit L2b to increase the sensitivity during image stabilization. Thus, reduction in lens diameter and image stabilizing mechanism in size is facilitated. A partial optical system L2r having a positive refractive power is preferably provided on the image side of the image stabilizing lens sub-unit L2b.

Next, Embodiment in which the optical system according to the present invention is applied to an image pickup apparatus (camera system) is described referring to FIG. 11. FIG. 11 is a schematic diagram of a main part of a single-lens reflex camera. In FIG. 11, a lens barrel 10 includes an optical system 1 of any one of Embodiments 1 to 5. The optical system 1 is held by a body tube 2 which is a holder member. A camera main body 20 includes a quick return mirror 3 configured to reflect a light flux from the optical system 1 upward, a focusing screen 4 located at an image formation position on the optical system 1, and a roof pentaprism 5 configured to convert an inverse image formed on the focusing screen 4 into an erected image. The camera main body 20 further includes an eyepiece lens 6 configured to observe the erected image and the like.

On a photosensitive surface 7, an image pickup element (photoelectric conversion element) such as a CCD sensor or a CMOS sensor and a silver-halide film are provided. At the time of photographing, the quick return mirror 3 retracts from an optical path such that an image is formed by the optical system 1 on the photosensitive surface 7. In this manner, by applying the optical system according to Embodiments 1 to 5 to an image pickup apparatus such as a photographing camera, a video camera, or a digital still camera, the image pickup apparatus that is small in weight and has excellent optical characteristics is realized. The optical system 1 of the present invention can be similarly applied to an image pickup apparatus without a quick return mirror.

The exemplary embodiments of the present invention are described above, but the present invention is not limited to those embodiments and can be modified and changed variously within the scope of the gist thereof.

Now, Numerical Embodiment 1 to 5 respectively corresponding to Embodiments 1 to 5 of the present invention are described. In each of Numerical Embodiment, i indicates the order of a surface counted from the object side, ri is a curvature radius of the i-th surface counted from the object side, di is an interval between the i-th surface and an (i+1)-th surface counted from the object side, ndi and νdi are a refractive index and an Abbe number of an optical member arranged between the i-th surface and the (i+1)-th surface, respectively. In Numerical Embodiment 1, Numerical Embodiment 4, and Numerical Embodiment 5, surface numbers 31 and 32 correspond to an optical member, for example, an optical filter. In Numerical Embodiment 3, surface numbers 32 and 33 correspond to an optical member, for example, an optical filter.

Values of the focal length, the F-number, the half angle of view (degree) are those obtained when focus is on an object at infinity. Moreover, a back focus BF is an equivalent air length from a last lens surface to the image plane. The lens total length is a value obtained by adding a back focus to a distance from the first lens surface to the last lens surface.

Further, the numerical data shows the focal length, the length on the optical axis, the front principal point position, and the rear principal point position of each lens unit. In lens unit data, a first unit corresponds to the first lens unit L1, a second unit corresponds to the focusing lens sub-unit L2a, a third unit corresponds to the lens sub-unit L2p, a fourth unit corresponds to the image stabilizing lens sub-unit L2b, and a fifth unit corresponds to the partial optical system L2r. The relationship between the conditional expressions described above and various numerical values in Numerical Embodiment is shown in Table 1.

### Numerical Embodiment 1

Unit mm
Surface data

| | | | | | Effective |
|---|---|---|---|---|---|
| Surface number i | ri | di | ndi | νdi | diameter |
| 1 | 150.642 | 16.15 | 1.59270 | 35.3 | 135.36 |
| 2 | 730.042 | 100.00 | | | 134.20 |
| 3 | 107.703 | 14.79 | 1.43387 | 95.1 | 84.27 |
| 4 | −328.442 | 0.27 | | | 82.15 |
| 5 | −318.403 | 3.00 | 1.85478 | 24.8 | 81.94 |
| 6 | 87.265 | 3.08 | | | 76.51 |
| 7 | 88.737 | 12.63 | 1.43387 | 95.1 | 76.87 |
| 8 | −1026.629 | 35.00 | | | 76.22 |
| 9 | 68.568 | 6.10 | 1.89286 | 20.4 | 62.07 |
| 10 | 127.179 | 5.00 | | | 60.58 |
| 11 | 68.368 | 2.30 | 1.65412 | 39.7 | 55.04 |
| 12 | 43.418 | 1.15 | | | 51.09 |
| 13 | 48.830 | 7.97 | 1.43387 | 95.1 | 51.07 |
| 14 | 133.424 | 7.57 | | | 49.03 |
| 15 (Stop) | ∞ | 5.89 | | | 44.73 |
| 16 | −3151.717 | 1.87 | 1.91082 | 35.3 | 40.00 |
| 17 | 61.271 | 30.34 | | | 38.04 |
| 18 | 97.234 | 1.76 | 1.92286 | 20.9 | 33.23 |
| 19 | 63.011 | 9.17 | 1.56732 | 42.8 | 32.60 |
| 20 | −96.758 | 1.07 | | | 33.13 |
| 21 | 110.488 | 4.14 | 1.85025 | 30.1 | 32.94 |
| 22 | −106.157 | 1.44 | 1.59522 | 67.7 | 32.67 |
| 23 | 36.770 | 5.26 | | | 31.17 |
| 24 | −77.293 | 1.47 | 1.72916 | 54.7 | 31.20 |
| 25 | 75.820 | 4.11 | | | 32.49 |
| 26 | 89.505 | 10.00 | 1.64769 | 33.8 | 36.21 |
| 27 | −216.973 | 0.15 | | | 38.52 |
| 28 | 77.954 | 12.44 | 1.73800 | 32.3 | 39.99 |
| 29 | −58.563 | 2.00 | 1.80809 | 22.8 | 39.98 |
| 30 | ∞ | 3.00 | | | 40.13 |
| 31 | ∞ | 2.20 | 1.51633 | 64.1 | 40.27 |
| 32 | ∞ | 20.70 | | | 40.34 |
| 33 | ∞ | 40.00 | | | 41.34 |
| Image plane | ∞ | | | | |

| | |
|---|---|
| Surface number 33 | Flare cut stop |

Various data

| | |
|---|---|
| Focal length | 392.55 |
| F-number | 2.90 |
| Half angle of view (degree) | 3.15 |
| Image height | 21.64 |
| Total lens length | 372.00 |
| BF | 40.00 |
| Entrance pupil position | 532.27 |
| Exit pupil position | −130.00 |
| Front principal point position | 18.38 |
| Rear principal point position | −352.55 |

Lens unit data

| | | | | Front | Rear |
|---|---|---|---|---|---|
| | | | Lens | principal | principal |
| | First | Focal | structure | point | point |
| Unit | surface | length | length | position | position |
| 1 | 1 | 175.07 | 215.00 | 163.73 | −118.69 |
| 2 | 16 | −65.97 | 1.87 | 0.96 | −0.02 |
| 3 | 18 | 104.42 | 10.93 | 3.62 | −3.29 |
| 4 | 21 | −40.08 | 12.31 | 8.78 | −0.66 |
| 5 | 26 | 55.10 | 50.49 | 3.40 | −36.30 |

Single lens data

| Lens | First surface | Focal length |
|---|---|---|
| 1 | 1 | 316.96 |
| 2 | 3 | 188.88 |
| 3 | 5 | −79.86 |
| 4 | 7 | 188.90 |
| 5 | 9 | 158.84 |
| 6 | 11 | −188.77 |
| 7 | 13 | 172.59 |
| 8 | 16 | −65.97 |
| 9 | 18 | −198.89 |
| 10 | 19 | 68.69 |
| 11 | 21 | 64.24 |
| 12 | 22 | −45.71 |
| 13 | 24 | −52.28 |
| 14 | 26 | 99.10 |
| 15 | 28 | 47.14 |
| 16 | 29 | −72.47 |
| 17 | 31 | 0.00 |

### Numerical Embodiment 2

Unit mm
Surface data

| | | | | | Effective |
|---|---|---|---|---|---|
| Surface number i | ri | di | ndi | νdi | diameter |
| 1 | 99.464 | 14.87 | 1.59270 | 35.3 | 101.04 |
| 2 | 456.909 | 64.58 | | | 99.29 |
| 3 | 80.681 | 11.90 | 1.43387 | 95.1 | 62.00 |
| 4 | −167.967 | 0.15 | | | 60.11 |
| 5 | −166.869 | 2.30 | 1.85478 | 24.8 | 59.92 |
| 6 | 51.072 | 0.15 | | | 54.95 |
| 7 | 50.726 | 11.60 | 1.43387 | 95.1 | 55.04 |
| 8 | −770.506 | 10.68 | | | 54.62 |
| 9 | 59.715 | 3.81 | 1.89286 | 20.4 | 50.66 |
| 10 | 74.063 | 8.36 | | | 49.33 |
| 11 | 58.185 | 2.00 | 1.65412 | 39.7 | 45.60 |
| 12 | 45.596 | 1.04 | | | 43.86 |
| 13 | 51.918 | 6.42 | 1.90366 | 31.3 | 43.79 |
| 14 | 206.154 | 3.00 | | | 42.24 |
| 15 (Stop) | ∞ | 2.91 | | | 40.40 |
| 16 | 2015.159 | 1.90 | 1.91082 | 35.3 | 37.51 |
| 17 | 32.641 | 3.50 | 1.84666 | 23.8 | 34.33 |
| 18 | 43.038 | 17.66 | | | 33.42 |
| 19 | 64.610 | 5.62 | 1.49700 | 81.5 | 31.81 |
| 20 | −78.046 | 1.00 | | | 31.84 |
| 21 | 469.814 | 3.84 | 1.85478 | 24.8 | 30.43 |
| 22 | −64.210 | 1.50 | 1.60311 | 60.6 | 30.18 |
| 23 | 33.512 | 7.59 | | | 28.87 |
| 24 | −47.827 | 1.50 | 1.60311 | 60.6 | 29.44 |
| 25 | 93.980 | 2.80 | | | 31.60 |
| 26 | 77.014 | 6.40 | 1.59551 | 39.2 | 36.97 |
| 27 | −82.425 | 0.42 | | | 37.69 |
| 28 | 108.793 | 10.03 | 1.85478 | 24.8 | 38.99 |
| 29 | −32.591 | 2.00 | 1.89286 | 20.4 | 38.97 |
| 30 | 1236.437 | 23.67 | | | 39.14 |
| 31 | ∞ | 40.00 | | | 39.62 |
| Image plane | ∞ | | | | |

| | |
|---|---|
| Surface number 31 | Flare cut stop |

Various data

| | |
|---|---|
| Focal length | 292.46 |
| F-number | 2.90 |
| Half angle of view (degree) | 4.23 |
| Image height | 21.64 |
| Total lens length | 273.23 |
| BF | 40.00 |
| Entrance pupil position | 301.22 |
| Exit pupil position | −93.14 |
| Front principal point position | −48.75 |
| Rear principal point position | −252.46 |

Lens unit data

| | | | | Front | Rear |
|---|---|---|---|---|---|
| | | | Lens | principal | principal |
| | First | Focal | structure | point | point |
| Unit | surface | length | length | position | position |
| 1 | 1 | 112.19 | 140.87 | 122.13 | −68.98 |
| 2 | 16 | −47.10 | 5.40 | 2.77 | −0.11 |
| 3 | 19 | 72.07 | 5.62 | 1.72 | −2.08 |
| 4 | 21 | −30.43 | 14.43 | 7.95 | −3.25 |
| 5 | 26 | 48.26 | 42.53 | 2.17 | −32.38 |

Single lens data

| Lens | First surface | Focal length |
|---|---|---|
| 1 | 1 | 211.24 |
| 2 | 3 | 127.46 |
| 3 | 5 | −45.53 |
| 4 | 7 | 110.16 |
| 5 | 9 | 306.80 |
| 6 | 11 | −343.79 |
| 7 | 13 | 75.30 |
| 8 | 16 | −36.44 |
| 9 | 17 | 138.24 |
| 10 | 19 | 72.07 |
| 11 | 21 | 66.31 |
| 12 | 22 | −36.30 |
| 13 | 24 | −52.35 |
| 14 | 26 | 67.87 |
| 15 | 28 | 30.33 |
| 16 | 29 | −35.54 |

### Numerical Embodiment 3

Unit mm
Surface data

| | | | | | Effective |
|---|---|---|---|---|---|
| Surface number i | ri | di | ndi | νdi | diameter |
| 1 | 178.783 | 15.20 | 1.59270 | 35.3 | 135.37 |
| 2 | 1415.744 | 124.89 | | | 134.32 |
| 3 | 108.327 | 15.15 | 1.43387 | 95.1 | 79.01 |
| 4 | −192.136 | 0.15 | | | 77.00 |
| 5 | −197.207 | 3.00 | 1.85478 | 24.8 | 76.70 |
| 6 | 76.176 | 0.15 | | | 71.87 |
| 7 | 73.738 | 12.64 | 1.43387 | 95.1 | 72.06 |
| 8 | 13386.147 | 11.63 | | | 71.70 |
| 9 | 86.704 | 5.89 | 1.89286 | 20.4 | 68.83 |
| 10 | 159.733 | 33.10 | | | 67.69 |
| 11 | 69.154 | 2.30 | 1.65412 | 39.7 | 49.91 |
| 12 | 45.945 | 1.53 | | | 47.31 |
| 13 | 55.402 | 8.24 | 1.66672 | 48.3 | 47.24 |
| 14 | 2426.623 | 3.00 | | | 45.62 |
| 15 (Stop) | ∞ | 2.00 | | | 42.93 |
| 16 | 174.740 | 2.00 | 1.90366 | 31.3 | 40.01 |
| 17 | 37.347 | 4.13 | 1.49700 | 81.5 | 36.74 |
| 18 | 52.890 | 15.51 | | | 35.69 |
| 19 | 87.342 | 4.14 | 1.84666 | 23.8 | 31.49 |
| 20 | 403.419 | 1.07 | | | 31.03 |
| 21 | 95.943 | 4.24 | 1.85478 | 24.8 | 30.90 |
| 22 | −94.709 | 1.50 | 1.76385 | 48.5 | 30.57 |
| 23 | 38.328 | 6.23 | | | 29.37 |
| 24 | −80.394 | 1.50 | 1.76385 | 48.5 | 29.87 |
| 25 | 109.369 | 3.26 | | | 31.12 |
| 26 | 72.385 | 12.53 | 1.67300 | 38.1 | 34.73 |
| 27 | −32.147 | 1.70 | 1.59522 | 67.7 | 35.96 |
| 28 | −300.120 | 0.15 | | | 37.28 |
| 29 | 144.097 | 9.42 | 1.85478 | 24.8 | 37.76 |
| 30 | −34.206 | 2.00 | 1.89286 | 20.4 | 37.78 |
| 31 | 1892.910 | 0.16 | | | 38.05 |
| 32 | ∞ | 2.20 | 1.51633 | 64.1 | 38.06 |
| 33 | ∞ | 21.34 | | | 38.18 |
| 34 | ∞ | 40.00 | | | 39.95 |
| Image plane | ∞ | | | | |

| | |
|---|---|
| Surface number 34 | Flare cut stop |

Various data

| | |
|---|---|
| Focal length | 392.56 |
| F-number | 2.90 |
| Half angle of view (degree) | 3.15 |
| Image height | 21.64 |
| Total lens length | 371.98 |
| BF | 40.00 |
| Entrance pupil position | 626.88 |
| Exit pupil position | −86.43 |
| Front principal point position | −199.43 |
| Rear principal point position | −352.56 |

Lens unit data

| | | | | Front | Rear |
|---|---|---|---|---|---|
| | | | Lens | principal | principal |
| | First | Focal | structure | point | point |
| Unit | surface | length | length | position | position |
| 1 | 1 | 156.52 | 236.90 | 265.60 | −109.21 |
| 2 | 16 | −66.00 | 6.13 | 3.14 | −0.67 |
| 3 | 19 | 130.88 | 4.14 | −0.62 | −2.84 |
| 4 | 21 | −37.58 | 13.47 | 8.56 | −1.76 |
| 5 | 26 | 57.11 | 49.51 | 3.71 | −34.28 |

Single lens data

| Lens | First surface | Focal length |
|---|---|---|
| 1 | 1 | 343.67 |
| 2 | 3 | 162.13 |
| 3 | 5 | −63.96 |
| 4 | 7 | 170.85 |
| 5 | 9 | 204.61 |
| 6 | 11 | −217.83 |
| 7 | 13 | 84.92 |
| 8 | 16 | −52.93 |
| 9 | 17 | 234.98 |
| 10 | 19 | 130.88 |
| 11 | 21 | 56.34 |
| 12 | 22 | −35.55 |
| 13 | 24 | −60.45 |
| 14 | 26 | 34.75 |
| 15 | 27 | −60.63 |
| 16 | 29 | 33.15 |
| 17 | 30 | −37.61 |
| 18 | 32 | 0.00 |

### Numerical Embodiment 4

Unit mm
Surface data

| | | | | | Effective |
|---|---|---|---|---|---|
| Surface number i | ri | di | ndi | νdi | diameter |
| 1 | 208.008 | 14.13 | 1.59270 | 35.3 | 135.36 |
| 2 | 7206.001 | 100.00 | | | 134.57 |
| 3 | 102.161 | 17.52 | 1.43387 | 95.1 | 90.92 |
| 4 | −306.165 | 0.15 | | | 88.87 |
| 5 | −339.338 | 3.00 | 1.85478 | 24.8 | 88.34 |
| 6 | 118.737 | 2.88 | | | 83.31 |
| 7 | 116.495 | 10.10 | 1.43387 | 95.1 | 83.11 |
| 8 | 1202.503 | 51.34 | | | 82.26 |
| 9 | 86.836 | 6.16 | 1.89286 | 20.4 | 61.81 |
| 10 | 254.093 | 5.00 | | | 60.56 |
| 11 | 57.448 | 2.30 | 1.80000 | 29.8 | 52.48 |
| 12 | 36.208 | 3.26 | | | 47.85 |
| 13 | 36.629 | 7.94 | 1.49700 | 81.5 | 46.84 |
| 14 | 74.088 | 5.14 | | | 44.63 |
| 15 (Stop) | ∞ | 2.78 | | | 43.23 |
| 16 | 930.568 | 1.87 | 1.77250 | 49.6 | 40.76 |
| 17 | 51.891 | 31.41 | | | 38.32 |
| 18 | 95.598 | 5.54 | 1.48749 | 70.2 | 35.28 |
| 19 | −105.886 | 1.07 | | | 35.34 |
| 20 | 66.809 | 4.91 | 1.85478 | 24.8 | 34.71 |
| 21 | −136.876 | 1.44 | 1.76385 | 48.5 | 34.23 |
| 22 | 34.423 | 5.56 | | | 31.99 |
| 23 | −91.121 | 1.47 | 1.76385 | 48.5 | 32.03 |
| 24 | 90.122 | 3.29 | | | 33.16 |
| 25 | 69.585 | 8.33 | 1.53172 | 48.8 | 36.59 |
| 26 | −52.105 | 1.70 | 1.49700 | 81.5 | 37.28 |
| 27 | −1696.825 | 0.15 | | | 38.67 |
| 28 | 96.717 | 9.15 | 1.85025 | 30.1 | 39.60 |
| 29 | −43.767 | 1.78 | 1.89286 | 20.4 | 39.64 |
| 30 | −1668.364 | 0.16 | | | 39.90 |
| 31 | ∞ | 1.79 | 1.51633 | 64.1 | 39.91 |
| 32 | ∞ | 20.70 | | | 39.98 |
| 33 | ∞ | 40.00 | | | 41.10 |
| Image plane | ∞ | | | | |

| | |
|---|---|
| Surface number 33 | Flare cut stop |

Various data

| | |
|---|---|
| Focal length | 392.55 |
| F-number | 2.90 |
| Half angle of view (degree) | 3.15 |
| Image height | 21.64 |
| Total lens length | 372.00 |
| BF | 40.00 |
| Entrance pupil position | 566.99 |
| Exit pupil position | −103.83 |
| Front principal point position | −111.85 |
| Rear principal point position | −352.55 |

Lens unit data

| | | | Lens | Front | |
|---|---|---|---|---|---|
| | First | Focal | structure | principal | Rear principal |
| Unit | surface | length | length | point position | point position |
| 1 | 1 | 172.96 | 228.92 | 180.95 | −119.45 |
| 2 | 16 | −71.21 | 1.87 | 1.12 | 0.06 |
| 3 | 18 | 103.99 | 5.54 | 1.78 | −1.97 |
| 4 | 20 | −40.48 | 13.38 | 9.81 | −0.48 |
| 5 | 25 | 60.60 | 43.75 | 3.64 | −31.18 |

Single lens data

| Lens | First surface | Focal length |
|---|---|---|
| 1 | 1 | 361.11 |
| 2 | 3 | 178.88 |
| 3 | 5 | −102.59 |
| 4 | 7 | 296.47 |
| 5 | 9 | 145.23 |
| 6 | 11 | −128.61 |
| 7 | 13 | 136.18 |
| 8 | 16 | −71.21 |
| 9 | 18 | 103.99 |
| 10 | 20 | 53.11 |
| 11 | 21 | −35.88 |
| 12 | 23 | −59.11 |
| 13 | 25 | 57.40 |
| 14 | 26 | −108.20 |
| 15 | 28 | 36.53 |
| 16 | 29 | −50.37 |
| 17 | 31 | 0.00 |

### Numerical Embodiment 5

Unit mm
Surface data

| | | | | | Effective |
|---|---|---|---|---|---|
| Surface number i | ri | di | ndi | νdi | diameter |
| 1 | 166.523 | 15.55 | 1.59270 | 35.3 | 135.36 |
| 2 | 1272.202 | 100.65 | | | 134.41 |
| 3 | 112.407 | 14.65 | 1.43387 | 95.1 | 85.33 |
| 4 | −324.415 | 0.25 | | | 83.33 |
| 5 | −316.995 | 3.00 | 1.85478 | 24.8 | 83.13 |
| 6 | 103.578 | 2.39 | | | 78.29 |
| 7 | 96.614 | 11.67 | 1.43387 | 95.1 | 78.34 |
| 8 | −2168.734 | 33.21 | | | 77.58 |
| 9 | 72.073 | 5.28 | 1.89286 | 20.4 | 62.10 |
| 10 | 123.904 | 6.92 | | | 60.79 |
| 11 | 68.870 | 2.30 | 1.72916 | 54.7 | 54.12 |
| 12 | 37.833 | 0.25 | | | 49.36 |
| 13 | 37.925 | 10.19 | 1.43387 | 95.1 | 49.31 |
| 14 | 166.510 | 3.70 | | | 47.52 |
| 15 (Stop) | ∞ | 2.73 | | | 45.91 |
| 16 | 877.121 | 1.87 | 1.95375 | 32.3 | 43.48 |
| 17 | 66.517 | 47.09 | | | 41.43 |
| 18 | 115.224 | 1.70 | 1.89286 | 20.4 | 36.19 |
| 19 | 51.707 | 9.28 | 1.73800 | 32.3 | 36.09 |
| 20 | −168.843 | 1.07 | | | 36.27 |
| 21 | 82.452 | 5.33 | 1.85478 | 24.8 | 35.87 |
| 22 | −86.086 | 1.44 | 1.76385 | 48.5 | 35.48 |
| 23 | 38.375 | 5.94 | | | 33.39 |
| 24 | −103.325 | 1.47 | 1.76385 | 48.5 | 33.55 |
| 25 | 78.254 | 4.26 | | | 34.82 |
| 26 | 90.391 | 4.75 | 1.85478 | 24.8 | 38.93 |
| 27 | −901.806 | 0.15 | | | 39.50 |
| 28 | 80.720 | 8.91 | 1.90366 | 31.3 | 40.70 |
| 29 | −55.815 | 2.00 | 1.89286 | 20.4 | 40.58 |
| 30 | 251.466 | 1.11 | | | 40.25 |
| 31 | ∞ | 2.20 | 1.51633 | 64.1 | 40.27 |
| 32 | ∞ | 20.70 | | | 40.34 |
| 33 | ∞ | 40.00 | | | 41.34 |
| Image plane | ∞ | | | | |

| | |
|---|---|
| Surface number 33 | Flare cut stop |

Various data

| | |
|---|---|
| Focal length | 392.55 |
| F-number | 2.90 |
| Half angle of view (degree) | 3.15 |
| Image height | 21.64 |
| Total lens length | 372.00 |
| BF | 40.00 |
| Entrance pupil position | 500.24 |
| Exit pupil position | −130.00 |
| Front principal point position | −13.64 |
| Rear principal point position | −352.55 |

Lens unit data

| | | | | Front | Rear |
|---|---|---|---|---|---|
| | | | Lens | principal | principal |
| | First | Focal | structure | point | point |
| Unit | surface | length | length | position | position |
| 1 | 1 | 176.27 | 210.00 | 143.87 | −117.93 |
| 2 | 16 | −75.55 | 1.87 | 1.04 | 0.08 |
| 3 | 18 | 111.06 | 10.98 | 2.74 | −3.61 |
| 4 | 21 | −39.79 | 14.19 | 10.03 | −0.78 |
| 5 | 26 | 54.25 | 39.81 | 0.26 | −31.29 |

Single lens data

| Lens | First surface | Focal length |
|---|---|---|
| 1 | 1 | 321.59 |
| 2 | 3 | 194.38 |
| 3 | 5 | −91.03 |
| 4 | 7 | 213.52 |
| 5 | 9 | 184.12 |
| 6 | 11 | −118.84 |
| 7 | 13 | 110.54 |
| 8 | 16 | −75.55 |
| 9 | 18 | −106.40 |
| 10 | 19 | 54.61 |
| 11 | 21 | 50.00 |
| 12 | 22 | −34.58 |
| 13 | 24 | −58.09 |
| 14 | 26 | 96.33 |
| 15 | 28 | 37.68 |
| 16 | 29 | −51.00 |
| 17 | 31 | 0.00 |

TABLE 1

| Conditional | Numerical Embodiment | | | | |
|---|---|---|---|---|---|
| Expression | 1 | 2 | 3 | 4 | 5 |
| (1) | 0.034 | 0.020 | 0.013 | 0.020 | 0.016 |
| (2) | −0.48 | −0.32 | −0.22 | −0.34 | −0.47 |
| (3) | −0.92 | −1.20 | −1.79 | −1.31 | −0.95 |
| (4) | 0.35 | 0.50 | 0.75 | 0.54 | 0.41 |
| (5) | 0.57 | 0.58 | 0.80 | 0.58 | 0.57 |
| (6) | 1.76 | 1.99 | 2.90 | 2.14 | 1.65 |
| (7) | 0.95 | 0.93 | 0.95 | 0.95 | 0.95 |
| (8) | 0.17 | 0.22 | 0.16 | 0.16 | 0.16 |
| (9) | 0.21 | 0.33 | 0.43 | 0.31 | 0.21 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-109877, filed Jun. 1, 2016, which is hereby incorporated by reference herein in its entirety.

What is claimed is:

1. An optical system, comprising, in order from an object side to an image side:
a first lens unit having a positive refractive power;
an aperture stop; and
a second lens unit having a negative refractive power,
the second lens unit comprising:
a focusing lens sub-unit which is moved during focusing; and
an image stabilizing lens sub-unit which is arranged on the image side of the focusing lens sub-unit and is moved in a direction having a component orthogonal to an optical axis during image stabilization,
the first lens unit consisting of, in order from the object side to the image side, a first lens sub-unit having a positive refractive power and a second lens sub-unit having a positive refractive power that are separated from each other by a widest air interval in the first lens unit on the optical axis,
wherein the following conditional expressions are satisfied:
0.005<d12/f<0.045; and
0.4<d1/f1<1.2,
where f represents a focal length of the optical system, d12 represents a distance between the first lens unit and the second lens unit on the optical axis when focused at infinity, d1 represents a distance between the first lens sub-unit and the second lens sub-unit on the optical axis, and f1 represents a focal length of the first lens unit.

2. An optical system according to claim 1, wherein the following conditional expression is satisfied:
−0.53<f2/f<−0.19,
where f2 represents a focal length of the second lens unit.

3. An optical system according to claim 1, wherein the following conditional expression is satisfied:
−1.90<f1/f2<−0.80,
where f2 represents a focal length of the second lens unit.

4. An optical system according to claim 1, wherein the following conditional expression is satisfied:
0.30<f2a/f2<0.80,
where f2a represents a focal length of the focusing lens sub-unit, and f2 represents a focal length of the second lens unit.

5. An optical system according to claim 1, wherein the following conditional expression is satisfied:
1.4<f1a/f1b<7.0,
where f1a represents a focal length of the first lens sub-unit, and f1b represents a focal length of the second lens sub-unit.

6. An optical system according to claim 1, wherein the following conditional expression is satisfied:
0.8<Lo/f<1.1,
where Lo represents a distance from a lens surface closest to the object side to an image plane on the optical axis.

7. An optical system according to claim 1, wherein the following conditional expression is satisfied:
0.09<Sk/f<0.25,
where Sk represents a distance from a lens surface closest to the image side to an image plane on the optical axis.

8. An optical system according to claim 1, wherein the first lens sub-unit consists of a single lens element.

9. An optical system according to claim 1, wherein the focusing lens sub-unit is arranged on the image side of and adjacent to the aperture stop.

10. An optical system according to claim 1, wherein a lens surface of the first lens unit that is closest to the image side is concave on the image side.

11. An optical system according to claim 1, wherein the image stabilizing lens sub-unit consists of a single lens element.

12. An optical system according to claim 1, wherein the focusing lens sub-unit is moved toward the image side during focusing from infinity to close distance.

13. An optical system according to claim 1, wherein the following conditional expression is satisfied:
0.15<f2b/f2<0.50,
where f2b represents a focal length of the image stabilizing lens sub-unit, and f2 represents a focal length of the second lens unit.

14. An optical system according to claim 1, further comprising a lens sub-unit having a positive refractive power disposed between the focusing lens sub-unit and the image stabilizing lens sub-unit.

15. An optical system according to claim 1, wherein only the focusing lens sub-unit comprises a lens unit which is moved during focusing.

16. An optical system, comprising, in order from an object side to an image side:
a first lens unit having a positive refractive power;
an aperture stop; and
a second lens unit having a negative refractive power,
the second lens unit comprising:
a focusing lens sub-unit which is moved during focusing; and
an image stabilizing lens sub-unit, which is arranged on the image side of the focusing lens sub-unit, and is moved in a direction having a component orthogonal to an optical axis during image stabilization, the image stabilizing lens sub-unit having a negative refractive power,
wherein the following conditional expression is satisfied:
0.005<d12/f<0.045,
where f represents a focal length of the optical system, and d12 represents a distance between the first lens unit and the second lens unit on the optical axis when focused at infinity.

17. An image pickup apparatus, comprising:
an optical system; and
an image pickup element which receives an image formed by the optical system,
the optical system comprising, in order from an object side to an image side:
a first lens unit having a positive refractive power;
an aperture stop; and
a second lens unit having a negative refractive power,
the second lens unit comprising:
a focusing lens sub-unit which is moved during focusing; and
an image stabilizing lens sub-unit, which is arranged on the image side of the focusing lens sub-unit, and is moved in a direction having a component orthogonal to an optical axis during image stabilization,
the first lens unit consisting of, in order from the object side to the image side, a first lens sub-unit having a positive refractive power and a second lens sub-unit having a positive refractive power that are separated from each other by a widest air interval in the first lens unit on the optical axis,
wherein the following conditional expressions are satisfied:
0.005<d12/f<0.045; and
0.4<d1/f1<1.2,
where f represents a focal length of the optical system, d12 represents a distance between the first lens unit and the second lens unit on the optical axis when focused at infinity, d1 represents a distance between the first lens sub-unit and the second lens sub-unit on the optical axis, and f1 represents a focal length of the first lens unit.
